(19) United States
(12) Patent Application Publication
(10) Pub. No.: US 2024/0119265 A1
(43) Pub. Date: Apr. 11, 2024

(54) Koopman Neural Forecaster for Time Series with Temporal Distribution Shifts

(71) Applicant: Google LLC, Mountain View, CA (US)

(72) Inventors: Sercan Omer Arik, San Francisco, CA (US); Yihe Dong, New York, NY (US); Qi Yu, San Diego, CA (US); Rui Wang, Mountain View, CA (US)

(21) Appl. No.: 18/373,417

(22) Filed: Sep. 27, 2023

Related U.S. Application Data
(60) Provisional application No. 63/410,868, filed on Sep. 28, 2022.

(51) Int. Cl. G06N 3/0455; G06N 3/08

(52) U.S. Cl. CPC G06N 3/0455; G06N 3/08

(57) ABSTRACT

Aspects of the disclosure provide a deep sequence model, referred to as Koopman Neural Forecaster (KNF), for time series forecasting. KNF leverages deep neural networks (DNNs) to learn the linear Koopman space and the coefficients of chosen measurement functions. KNF imposes appropriate inductive biases for improved robustness against distributional shifts, employing both a global operator to learn shared characteristics, and a local operator to capture changing dynamics, as well as a specially-designed feedback loop to continuously update the learnt operators over time for rapidly varying behaviors. KNF achieves superior performance on multiple time series datasets that are shown to suffer from distribution shifts.

### CROSS-REFERENCE TO RELATED APPLICATIONS

The present application claims priority to U.S. Provisional Application No. 63/410,868, filed Sep. 28, 2022, the disclosure of which is hereby incorporated by reference herein.

### BACKGROUND

Temporal distribution shifts occur commonly in many real-world time-series applications, from forecasting stock prices to detecting and monitoring sensory measures, to predicting fashion trend-based sales. Such distribution shifts over time might be caused by the data being generated in a highly dynamic and non-stationary environment, abrupt changes that are difficult to predict, or constantly evolving trends in the underlying data distribution. It has been shown that temporal distribution shifts pose a fundamental challenge for time-series forecasting. When the distribution shifts between the training and test domains are considered, numerous advanced meta or transfer learning approaches have been proposed. However, distribution shifts occurring continuously over time remain a problem for deep neural networks (DNNs).

With regard to temporal distribution shifts, various statistical estimation methods have been studied, including spectral density analysis, sample reweighting, and Bayesian state-space models. However, these methods are limited to low capacity auto-regressive models and are typically designed for short-horizon forecasting. For large-scale complex time series data, deep learning models increasingly outperform traditional statistical methods. Yet, most deep learning approaches are designed for stationary time series data that have clear seasonal and trend patterns. For distribution shifts, DNNs have been shown to be problematic in forecasting on data with varying.

DNNs are black-box models and often require a large number of samples to learn. For time series with continuous distribution shifts, the number of samples from a given distribution is small, thus DNNs would struggle to adapt to the changing distribution and may therefore provide inaccurate results. Furthermore, the non-linear dependencies in a DNN are difficult to interpret or manipulate. Directly modifying the parameters based on the change in dynamics may lead to undesirable effects.

### BRIEF SUMMARY

The present disclosure describes a Koopman-based deep sequence model for time series forecasting. A Koopman Neural Forecaster (KNF) leverages DNNs to learn a linear Koopman space and corresponding measurement functions. KNF imposes appropriate inductive biases for improved robustness against distributional shifts, employing both a global operator to learn shared characteristics, and a local operator to capture changing dynamics, as well as a feedback loop to continuously update the operators over time for rapidly varying behaviors. KNF achieves superior performance compared to alternatives, on a wide range of time series datasets that are particularly known to suffer from distribution shifts.

KNF brings multiple benefits to time series forecasting with distribution shifts. Such benefits include using predefined measurement functions, such as exponential, polynomial, etc., to provide sufficient expressivity for the time series without requiring a large number of samples. Further, since the Koopman operator is linear, it is much easier to analyze and manipulate. For instance, it can be used to perform spectral analysis and examine its eigenfunctions to reach a better understanding of the frequency of oscillation. Further, a feedback loop makes the Koopman operator adaptive to a non-stationary environment. As a result, predictions are more accurate.

One aspect of the disclosure provides a method for time-series forecasting, comprising encoding, with an encoder, multiple steps of observations of non-stationary time-series events in a lookback window into corresponding measurement vectors; applying, with one or more processors, predefined measurement functions with learned coefficients to the measurement vectors; determining, with the one or more processors based on analysis of the observations, Koopman operators; generating, with the one or more processors, a forecast vector based on the measurement vectors and Koopman operators; and providing, with the one or more processors a forecast for output based on the forecast vector. Learning the coefficients may be performed by an encoder, such that Ω: [symbol] ^{dxk}→ [symbol] ^{nxdxk} every time, where n represents a number of measurement functions for each feature, d represents a number of features in a time series, and k represents a number of steps encoded by the encoder.

The method may further include computing a latent matrix in which each measurement vector is a different linear transformation of a respective observation at a corresponding time step; and applying the measurement functions to the latent matrix.

The method may further include reconstructing, using a decoder, observations from the forecast vector. The encoder and the decoder may be any deep neural network architecture including multi-layer perceptron. The encoder may approximate parameters of the measurement functions without directly learning non-stationary characteristics. The deep neural network may be trained based on historic time-series data, which may be specific to a context for which the deep neural network will be used to generate predictions. Such historic time series data may include one or more parameters related to various events.

According to some examples, the predefined measurement functions may contain at least one of polynomials, exponential functions, trigonometric functions, or other interaction functions.

According to some examples, the predefined measurement functions may impose inductive biases into the forecast.

According to some examples, the Koopman operator may be a finite matrix using a global operator and a local operator to model propagation of dynamics. The method may further include applying the global operator and the local operator recursively to measurements to obtain predictions on a lookback window. The method may further include adjusting the Koopman operator based on differences between the predictions on the lookback window and a ground truth.

Another aspect of the disclosure provides a system for time-series forecasting, comprising memory and one or more processors in communication with the memory. The one or more processors may be configured to encode, using an encoder, multiple steps of observations of non-stationary time-series events in a lookback window into corresponding measurement vectors; apply predefined measurement functions with learned coefficients to the measurement vectors; determine, based on analysis of the observations, Koopman operators; generate a forecast vector based on the measurement vectors and Koopman operators; and provide a forecast for output based on the forecast vector.

Generating the forecast vector may include computing a latent matrix in which every vector is a linear transformation of a respective observation at a corresponding time step; and applying the measurement functions to the latent matrix. In some examples, generating the forecast vector may further comprise reconstructing, using a decoder, observations from the forecast vector. The encoder and the decoder may be any deep neural network architecture including multi-layer perceptron.

According to some examples, the predefined measurement functions may contain at least one of polynomials, exponential functions, trigonometric functions, or other interaction functions. The predefined measurement functions may impose inductive biases into the forecast. The encoder may approximate parameters of the measurement functions without directly learning non-stationary characteristics.

According to some examples, the Koopman operator may be a finite matrix using a global operator and a local operator to model propagation of dynamics.

The one or more processors may be further configured to apply the global operator and the local operator recursively to measurements to obtain predictions on a lookback window. The one or more processors may be further configured to adjust the Koopman operator based on differences between the predictions on the lookback window and ground truth.

Yet another aspect of the disclosure provides a non-transitory computer-readable medium storing instructions executable by one or more processors for performing a method, comprising: encoding multiple steps of observations of non-stationary time-series events in a lookback window into corresponding measurement vectors; applying predefined measurement functions with learned coefficients to the measurement vectors; determining, based on analysis of the observations, Koopman operators; generating a forecast vector based on the measurement vectors and Koopman operators; and providing a forecast for output based on the forecast vector.

### BRIEF DESCRIPTION OF THE DRAWINGS

FIG. 1 illustrates an example architecture of a deep forecasting model based on Koopman theory for time-series data with temporal distributional shifts according to aspects of the disclosure.

FIG. 2 depicts a block diagram of an example time series forecasting system according to aspects of the disclosure.

FIG. 3 depicts a block diagram of an example environment for implementing a time series forecasting system according to aspects of the disclosure.

FIG. 4 depicts a block diagram illustrating one or more model architectures according to aspects of the disclosure.

FIG. 5 depicts a flow diagram of an example process for performing time series forecasting according to aspects of the disclosure.

FIG. 6 is a graph illustrating forecasts in a first example use case according to aspects of the disclosure.

FIG. 7A is a graph illustrating forecasts in a second example use case according to aspects of the disclosure.

FIG. 7B is a top view depiction of forecasted basketball player trajectories relative to a basketball court according to aspects of the disclosure.

FIG. 8A is a table illustrating an ablation study of KNF on weekly data, according to aspects of the disclosure.

FIGS. 8B-C are graphs illustrating example M4 Competition predictions from KNF, according to aspects of the disclosure.

### DETAILED DESCRIPTION

The present disclosure provides a Koopman Neural Forecaster (KNF) model. The KNF model is a Koopman-based deep forecasting model for time-series data with temporal distributional shifts. The proposed approach allows the Koopman matrix to both capture the global behaviors and evolve over time to adapt to local changing distributions, with state-of-the-art performance on highly non-stationary time series datasets, such as competitions (e.g., M4 Competition of forecasting methods), cryptocurrency return forecasting, and sports player trajectory prediction. Interpretable insights for the model behavior may be generated via eigenvalues and eigenfunctions of the Koopman operators.

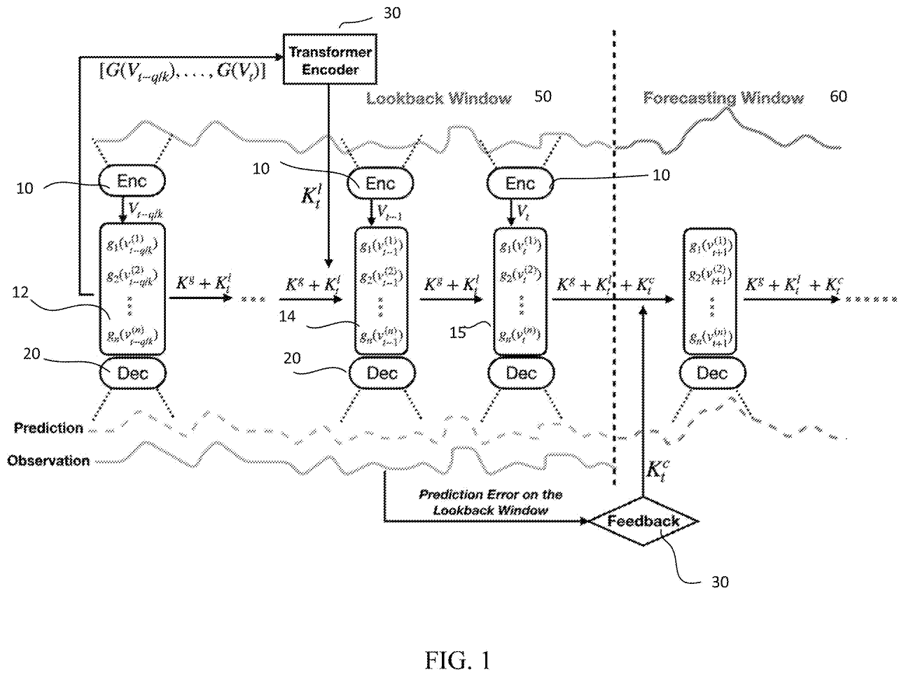

FIG. 1 illustrates an example architecture of the KNF model. Encoder 10 is used to encode observations at multiple time steps in lookback window 50 into a measurement vector G(Vₜ)=[g₁(v₁^{(l)}), . . . , gₙ(vₜ⁽ⁿ⁾)]. For example, measurement vector 12 is computed at a first time step, measurement vector 14 is computed at a second time step, measurement vector 15 is computed at a third time step, etc. While three time steps in the lookback window 50 are illustrated as having computed vectors, it should be understood that numerous vectors may be computed at additional time steps as well. G(V t) is computed based on a set of predefined measurement functions G and their input values V t learned by the encoder 10.

The model utilizes a global operator K^{g} and an adaptive local operator

$${K}_{t}^{l}$$

learned by a Transformer encoder 30 to model the evolution of measurements. In forecasting window 60, an additional adjustment operator

$${K}_{t}^{c}$$

is learned by a feedback module 30 based on the prediction error on the lookback window 50. The feedback module 30 may be, for example, a multilayer perceptron (MLP) module.

Time series data {xₜ}ₜ₌₁^{T} can be considered as observations of dynamical system states. For discrete form xₜ₊₁=F(xₜ), where x∈χ⊆ [symbol] ^{d} is the system state, and F is the underlying governing equation, a multi-step forecasting task of predicting the future states given a sequence of past observations may include seeking a function map f such that:

f:(x_{t-q+1}, . . . , xₜ)→(xₜ₊₁, . . . , xₜ₊ₕ)

where q is the lookback window length and h is the forecasting window length.

Koopman theory shows that any nonlinear dynamic system can be modeled by an infinite-dimensional linear Koopman operator acting on the space of all possible measurement functions. More specifically, there exists a linear infinite-dimensional operator [symbol] : [symbol] (χ) [symbol] [symbol] (χ) that acts on a space of real-valued measurement functions [symbol] (χ):={g:χ [symbol] [symbol] }. The Koopman operator maps between function spaces and advances the observations of the state to the next step:

[symbol]

g(xₜ)=g(F(xₜ))=g(xₜ₊₁).

KNF can be used to forecast highly non-stationary time series, as shown in FIG. 1. It instantiates an encoder-decoder architecture for each time series segment. An encoder 10 takes in observations from multiple time steps as the underlying dynamics may contain higher-order time derivatives.

The KNF model uses predefined measurement functions with learned coefficients to map time series to the functional space. The model employs both a global Koopman operator to learn the shared characteristics and a local Koopman operator to capture the local changing dynamics. The model also integrates a feedback loop to update the learned operators over time based on forecasting error, maintaining the model's long-term forecasting performance.

The KNF model may leverage predefined measurement functions. For example, a set of measurement functions spanning the Koopman space may be defined as: G:=[g₁, . . . gₙ], where each gᵢ: [symbol] [symbol] [symbol] . As an example, g₁(x)=sin (x). Such functions may be canonical nonlinear functions and may be used to model complex dynamical systems. They also provide a sample-efficient approach to represent highly nonlinear behavior that may be difficult to learn for DNNs.

An encoder may be used to generate coefficients of measurement functions Ω(Xₜ), such as the frequencies of sine functions. Where n represents the number of measurement functions for each feature, and d represents the number of features in a time series, and k represents the number of steps encoded by the encoder, W: [symbol] ^{dxk} [symbol] [symbol] ^{nxdxk} every time. Length q of the lookback window is a multiple of k. X_{tk:(t+1)k} may be denoted as Xt∈ [symbol] ^{dxk}.

A latent matrix Vₜ=(vₜ⁽¹⁾, vₜ⁽²⁾, . . . , vₜ⁽ⁿ⁾)∈ [symbol] ^{n×d} may be obtained using the following equation:

$${V}_{t} [ i , j ] = {\sum }_{i} Ψ ( {X}_{t} ) [ i , j , l ] {X}_{t} [ j , l ] ; 1 \leq i \leq n , 1 \leq j \leq d , 1 \leq l \leq k .$$

Where every vector vᵢ∈ [symbol] ^{d} is a different linear transformation of the observations, and where the weights are learned by the encoder Ω. The measurement functions may be defined in the latent space, rather than the observational space. Applying a set of predefined measurement functions G to the latent matrix Vₜ:

G(Vₜ)=[g₁(vᵢ⁽¹⁾),g₂(vᵢ⁽²⁾), . . . gₙ(vₜ⁽ⁿ⁾)]∈ [symbol] ^{n×d}

In some implementations, G(Vₜ) may be flattened into a vector, and then a finite Koopman operator should be a nd×nd matrix. A decoder 20 may be used to reconstruct the observations from the measurements. For example, decoder may be Φ: [symbol] ^{n×d} [symbol] [symbol] ^{k×d} and used to construct observations from the following measurements:

\hat{X}ₜ=Φ( [symbol] (Vₜ)).

The encoder 10 and decoder 20 may be any DNN architecture. In some examples, MLP may be used. The set of measurement functions G contains polynomials, exponential functions, trigonometric functions, interaction functions, etc. Such predefined measurement functions may be used to impose inductive biases into the model and to help capture non-linear behaviors of time series. The encoder model may approximate only the parameters of the functions without needing to directly learn non-stationary characteristics.

Global and Local Koopman Operators

Koopman operators may be identified using DNNs, dynamic mode decomposition (DMD), or other techniques. The encoder 10 may learn a finite approximation of measurement vector G(Vₜ), which forms a finite Koopman-invariant subspace. The Koopman operator K may be the finite matrix that best advances the measurements forward in time. While the Koopman matrix should vary across samples and time, it should also capture global behaviors. Using both global operator K^{g} and local operator

$${K}_{t}^{l}$$

to model the propagation of dynamics in the Koopman space, the Koopman matrix may be defined as:

$$K G ( {V}_{t} ) := ( {K}^{g} + {K}_{t}^{l} ) G ( {V}_{t} ) = G ( {V}_{t + 1} ) , t \geq 0$$

The global operator K^{g} may be a nd×nd trainable matrix that is shared across all time series. The global operator K^{g} may be used to learn shared behavior, such as a trend. The local operator

$${K}_{t}^{l}$$

may be based on measurement functions on the lookback window for each sample. The local operator should capture the local dynamics specific to each sample. Forecasts may be generated in an autoregressive way, and therefore the local operator depends on time t and varies across autoregressive steps, adapting to distribution changes along prediction. Using a Transformer architecture with a single-head as the encoder, relationships between measurements may be captured at different steps. An attention weight matrix may be used in the last layer as the local Koopman operator.

Feedback Loop

The architecture further includes an additional feedback loop, which may be a closed-loop feedback. In this closed-loop feedback, an MLP module Γ may be employed to learn the adjustment operator

$${K}_{t}^{c}$$

based on the prediction errors in the lookback window. The MLP module Γ is directly added to other operators when making predictions on the forecasting window, as shown in FIG. 1. Global and local operators are applied recursively to the measurements at the first step in the lookback window to obtain predictions:

\hat{X}_{t-q/k+i}=Φ(( [symbol] ^{g}+ [symbol] ₜ^{t})ⁱ [symbol] (V_{t-q/k})), 0<i≤q/k.

Then, the feedback module F uses the difference between the predictions on the lookback window and the observed data to generate additional adjustment operator

$${K}_{t}^{c} ,$$

which may be a diagonal matrix:

[symbol]

ₜ^{c}=Γ(\hat{X}_{t-q/k:t}−X_{t-q/k:t})=Γ(\hat{x}t−_{q:t}−x_{t-q:t})

If the predictions deviate significantly from the ground truth within the lookback window, the operator Kₜ^{c} would learn the temporal change in the underlying dynamics and correspondingly adjust the other two operators. For forecasting, the sum of all three operators may be used:

\hat{X}ₜ₊ᵢ=Φ(( [symbol] ^{g}+ [symbol] ₜ^{l}+ [symbol] ₜ^{c})ⁱ [symbol] (Vₜ)), i>0.

The feedback module may detect the distributional shifts in the lookback window and adapt the global and local operator to the latest distribution in the lookback window.

Loss Functions

KNF may be trained in an end-to-end fashion, using superposition of three loss terms: reconstruction loss (L_{rec}), prediction loss on the lookback window (L_{back}), and prediction accuracy in the forecasting window (L_{forw}), where L=L_{rec}+L_{back}+L_{forw}. A distance metric, using L2 loss, is represented by: l.

The reconstruction loss may be computed to ensure that decoder 1 can reconstruct the time series from the measurements. The reconstruction loss may be computed as:

L_{rec}=l(Xₜ, Φ( [symbol] (Ω(Xₜ)Xₜ))), t≥0.

The prediction loss on the lookback window may be computed to ensure the sum of the global and local operators in the best-fit propagation matrix on the lookback window. The prediction loss on the lookback window may be computed as:

L_{back}=l(X_{t-q/k+i}, Φ(( [symbol] ^{g}+ [symbol] ₜ^{l})ⁱ [symbol] (W(X_{t-q/k})X_{t-q/k})), 0<i≤q/k.

The prediction accuracy in the forecasting window may be computed to guide the feedback loop to learn the correct adjustment placed on the Koopman operator:

L_{forw}=l(Xₜ₊ᵢ, Φ(( [symbol] ^{g}+ [symbol] ₜ^{l}+ [symbol] ₜ^{c})ⁱ [symbol] (Vₜ)), i>0.

Training the Models

Different training strategies may be used to improve the prediction accuracy of the KNF model. One example strategy is reversible instance normalization, which normalizes the input sequence of de-normalizes the predictions at every autoregressive step for every instance. Another example strategy is temporal bundling, which asks autoregressive models to generate multiple-step predictions instead of just one on every call, to reduce a number of model calls and therefore error propagations speed.

Training samples may be generated using a sliding window approach. For example, for a dataset, a grid search of hyperparameters may be performed. Examples of such hyperparameters may include learning rate, input length, hidden dimension, number of predictions made in each autoregressive step, etc. Hyperparameter may be tuned separately for different modules in a model. For example, the number of layers may be tuned separately from the hidden dimensions. The encoder and decoder may have a different number of layers. Ranges for hyperparameter tuning may vary.

According to some examples, a default set of measurement functions used in KNF may include polynomials up to the order of four, an exponential function, and trigonometric functions with the same number of input steps for each feature, as well as pairwise product interaction functions between features if the time series data is multivariate.

### Example Use Cases/Datasets

The KNF model may be used for predictions in any of a variety of contexts.

Some example contexts are predicting values for cryptocurrencies, predicting trajectories for athletes such as basketball players, etc. The dataset used for predictions in the cryptocurrency context may include, for example, features of historical trades. Such features may include open and close prices, etc. The dataset used for athlete trajectories may include, for example, historical player movement trajectories. The KNF model achieves accurate prediction performance for such datasets that have low forecastability, no clear trends on seasonality, low sensitivity to initial conditions, etc.

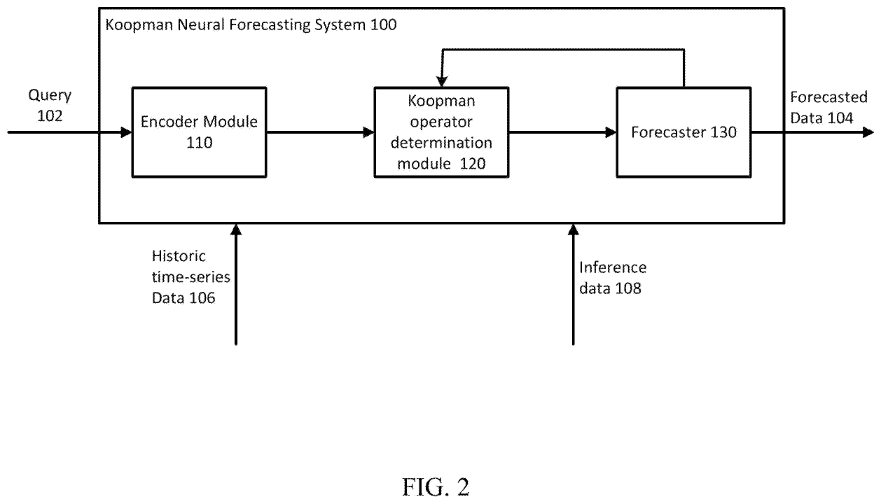

FIG. 2 depicts a block diagram of an example Koopman neural forecasting system 100. The Koopman neural forecasting system 100 may be part of a remote system in communication with one or more user devices via a network. The remote system may be a single computer, multiple computers, or a distributed system like a cloud environment. The remote system may include computing resources, such as data processing hardware, and storage resources, such as memory hardware. A data store, such as a remote storage device, may be overlain on the storage resources to allow scalable use of the storage resources by one or more of the clients, such as the user devices, or the computing resources. The data store can be configured to store a plurality of data blocks within one or more tables, such as a cloud database, that each include a plurality of rows and columns. The data store may store any number of tables at any point in time.

The Koopman neural forecasting system 100 can be configured to receive a time series forecasting query 102, such as from a user device via the network. The user device may correspond to any computing device, such as a desktop workstation, a laptop workstation, or a mobile device, such as a smart phone. The user device can include computing resources and storage resources. The query may be natural language or standard query language (SQL). Each Koopman neural forecasting query 102 can request one or more time series forecasts for the Koopman neural forecasting system 100 to generate a forecast of future data 104 based on current data 106. The Koopman neural forecasting system 100 can forecast and return forecasted future data 104, such as to the user device via the network as a query response.

The Koopman neural forecasting system 100 can include encoder module 110, Koopman operator determination module 120, and a forecaster 130. The system 100 can be configured to generate and train a forecasting model for each forecast request in the query 102. The model may be trained based on historic time-series data 106. Such historic time series data 106 may include one or more parameters related to various events. For example, for cryptocurrency value, the historic time series data may include parameters such as dates, times, crypto valuation, world events, etc. Each event may be, for example, a purchase, trade, closing, etc.

The system 100 can be configured to perform hyper-parameter tuning or optimization when generating and training the forecaster 130. A hyper-parameter may refer to a parameter that controls or adjusts learning process of the models while other parameters, such as node weights, are learned. For example, the system 100 can perform hyper-parameter tuning on a data frequency and non-seasonal order parameters.

The forecaster 130 can be configured to use information from the encoder module 110 and the Koopman operator determination module 120 to generate predictions responsive to the query 102 and based on inference data 108. The forecaster 130 can return the forecasted future data 104 to the user device, which can display the forecasted data 104, such as via a graph. Each time series requested by the query 102 can be displayed on the graph with configurable filters for controlling which portions of which time series are displayed. For example, the query 102 can include a request for ten time series forecasts. After receiving the future data 104, the user device can display on a graph with all ten time series forecasts simultaneously. The display can be adjusted on the user device to change which times series are viewable, as well as zoom in or zoom out on the graph as desired.

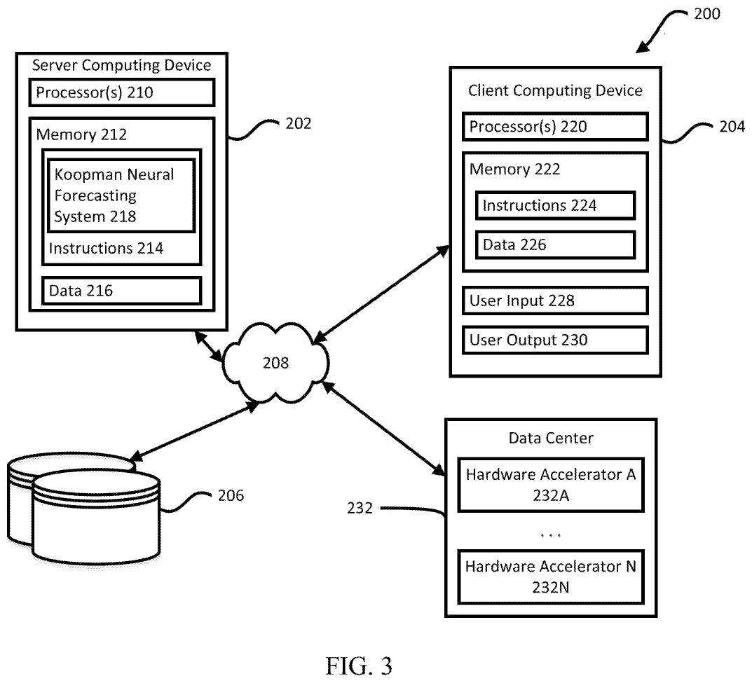

FIG. 3 depicts a block diagram of an example environment 200 for implementing a Koopman neural forecasting system 218. The Koopman neural forecasting system 218 can be implemented on one or more devices having one or more processors in one or more locations, such as in server computing device 202. Client computing device 204 and the server computing device 202 can be communicatively coupled to one or more storage devices 206 over a network 208. The storage devices 206 can be a combination of volatile and non-volatile memory and can be at the same or different physical locations than the computing devices 202, 204. For example, the storage devices 206 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 202 can include one or more processors 210 and memory 212. The memory 212 can store information accessible by the processors 210, including instructions 214 that can be executed by the processors 210. The memory 212 can also include data 216 that can be retrieved, manipulated, or stored by the processors 210. The memory 212 can be a type of non-transitory computer readable medium capable of storing information accessible by the processors 210, such as volatile and non-volatile memory. The processors 210 can include one or more central processing units (CPUs), graphic processing units (GPUs), field-programmable gate arrays (FPGAs), and/or application-specific integrated circuits (ASICs), such as tensor processing units (TPUs).

The instructions 214 can include one or more instructions that, when executed by the processors 210, cause the one or more processors to perform actions defined by the instructions 214. The instructions 214 can be stored in object code format for direct processing by the processors 210, or in other formats including interpretable scripts or collections of independent source code modules that are interpreted on demand or compiled in advance. The instructions 214 can include instructions for implementing a Koopman neural forecasting system 218, which can correspond to the time series forecasting system 100 of FIG. 2. The Koopman neural forecasting system 218 can be executed using the processors 210, and/or using other processors remotely located from the server computing device 202.

The data 216 can be retrieved, stored, or modified by the processors 210 in accordance with the instructions 214. The data 216 can be stored in computer registers, in a relational or non-relational database as a table having a plurality of different fields and records, or as JSON, YAML, proto, or XML documents. The data 216 can also be formatted in a computer-readable format such as, but not limited to, binary values, ASCII, or Unicode. Moreover, the data 216 can include information sufficient to identify relevant information, such as numbers, descriptive text, proprietary codes, pointers, references to data stored in other memories, including other network locations, or information that is used by a function to calculate relevant data.

The client computing device 204 can also be configured similarly to the server computing device 202, with one or more processors 220, memory 222, instructions 224, and data 226. The client computing device 204 can also include a user input 228 and a user output 230. The user input 228 can include any appropriate mechanism or technique for receiving input from a user, such as keyboard, mouse, mechanical actuators, soft actuators, touchscreens, microphones, and sensors.

The server computing device 202 can be configured to transmit data to the client computing device 204, and the client computing device 204 can be configured to display at least a portion of the received data on a display implemented as part of the user output 230. The user output 230 can also be used for displaying an interface between the client computing device 204 and the server computing device 202. The user output 230 can alternatively or additionally include one or more speakers, transducers or other audio outputs, a haptic interface or other tactile feedback that provides non-visual and non-audible information to the platform user of the client computing device 204.

Although FIG. 3 illustrates the processors 210, 220 and the memories 212, 222 as being within the computing devices 202, 204, components described herein can include multiple processors and memories that can operate in different physical locations and not within the same computing device. For example, some of the instructions 214, 224 and the data 216, 226 can be stored on a removable SD card and others within a read-only computer chip. Some or all of the instructions and data can be stored in a location physically remote from, yet still accessible by, the processors 210, 220. Similarly, the processors 210, 220 can include a collection of processors that can perform concurrent and/or sequential operation. The computing devices 202, 204 can each include one or more internal clocks providing timing information, which can be used for time measurement for operations and programs run by the computing devices 202, 204.

The server computing device 202 can be connected over the network 208 to a data center 232 housing any number of hardware accelerators 232A-N. The data center 232 can be one of multiple data centers or other facilities in which various types of computing devices, such as hardware accelerators, are located. Computing resources housed in the data center 232 can be specified for deploying models related to time series forecasting as described herein.

The server computing device 202 can be configured to receive requests to process data from the client computing device 204 on computing resources in the data center 232. For example, the environment 200 can be part of a computing platform configured to provide a variety of services to users, through various user interfaces and/or application programming interfaces (APIs) exposing the platform services. The variety of services can include performing time series forecasting. The client computing device 204 can transmit input data associated with requests for forecasts. The Koopman neural forecasting system 218 can receive the input data, and in response, generate output data including a forecast.

As other examples of potential services provided by a platform implementing the environment 200, the server computing device 202 can maintain a variety of models in accordance with different constraints available at the data center 232. For example, the server computing device 202 can maintain different families for deploying models on various types of TPUs and/or GPUs housed in the data center 232 or otherwise available for processing.

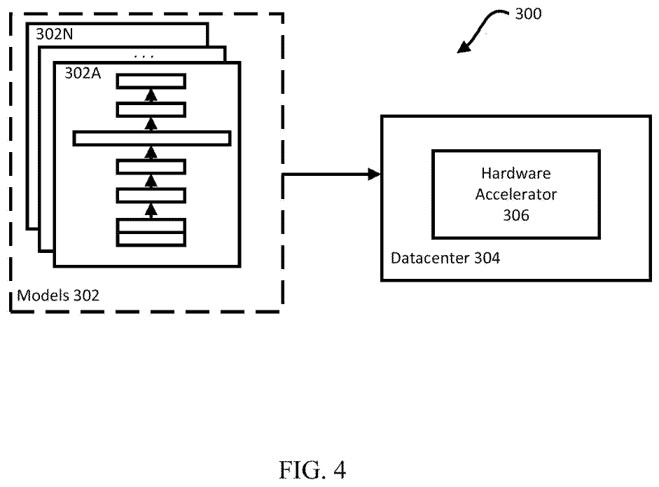

FIG. 4 depicts a block diagram 300 illustrating one or more model architectures 302, more specifically 302A-N for each architecture, for deployment in a data center 304 housing a hardware accelerator 306 on which the deployed models 302 will execute for providing forecasts. The hardware accelerator 306 can be any type of processor, such as a CPU, GPU, FPGA, or ASIC such as a TPU.

An architecture 302 of a model can refer to characteristics defining the model, such as characteristics of layers for the model, how the layers process input, or how the layers interact with one another. For example, the one or more models can be KNF models, and the one or more model architectures 302 may refer to different orders of the models, such as the number of time lags, different degrees of differencing, such as the number of times the data has had past values subtracted, and/or an order of the moving average model, such as a size of the moving average window. One or more model architectures 302 can be generated that can output results associated with forecasts.

Referring back to FIG. 3, the devices 202, 204 and the data center 232 can be capable of direct and indirect communication over the network 208. For example, using a network socket, the client computing device 204 can connect to a service operating in the data center 232 through an Internet protocol. The devices 202, 204 can set up listening sockets that may accept an initiating connection for sending and receiving information. The network 208 itself can include various configurations and protocols including the Internet, World Wide Web, intranets, virtual private networks, wide area networks, local networks, and private networks using communication protocols proprietary to one or more companies. The network 208 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 208, in addition or alternatively, can also support wired connections between the devices 202, 204 and the data center 232, including over various types of Ethernet connection.

Although a single server computing device 202, client computing device 204, and data center 232 are shown in FIG. 3, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

Referring back to FIG. 2, the query 102 can include a reference to one or more columns of a table stored in the data store associated with the current data 106. The one or more columns can include time series identification information, time series timestamp data, and the time series data itself. The time series timestamp column can include a time component of the time series. Each data element of the time series timestamp column can represent a point in time associated with a respective time series data element from the time series data column.

The Koopman neural forecasting system 100 can output the forecasted data 104 for display as a plot illustrating the time series and corresponding components of the time series. The time series can include a series of data points with respect to time. The time series can be decomposed into a trend component, a seasonal component, and a remainder portion. The trend component can represent trends in the data that move up or down in a reasonably predictable pattern. The trend component can also include cyclical variations that correspond to cycles, such as “boom-bust” cycles. The seasonal component can represent variations that repeat over a specific period, such as over a day, week, month, etc. The remainder component can represent seemingly random residual fluctuations that do not fall under classifications of other components.

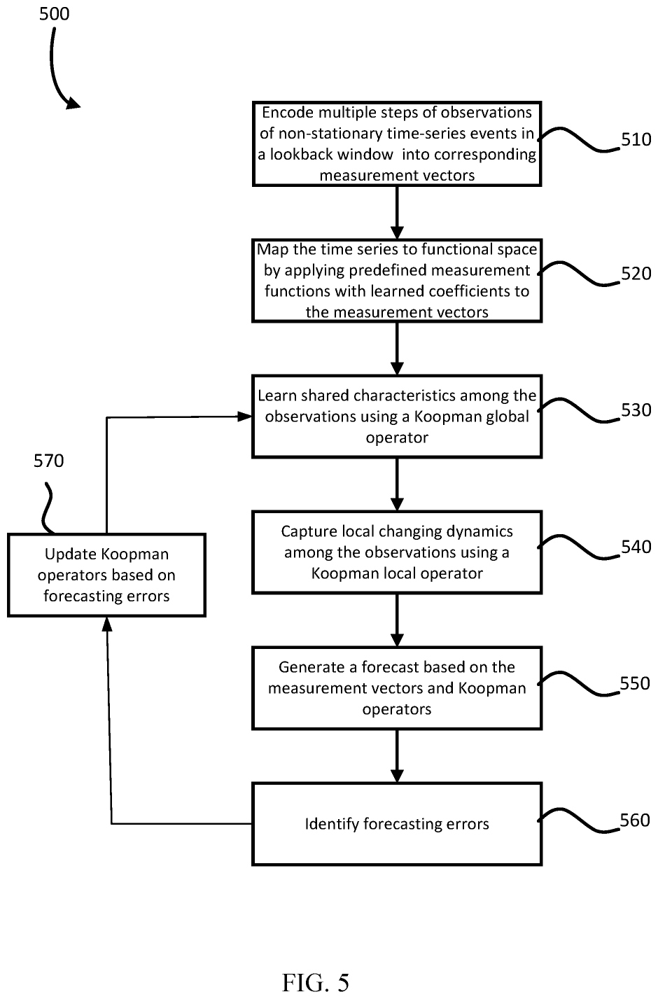

FIG. 5 depicts a flow diagram of an example process 500 for performing Koopman neural forecasting. The example process 500 can be performed on a system of one or more processors in one or more locations, such as the Koopman neural forecasting system 100 as depicted in FIG. 1.

As shown in block 510, multiple steps of observations of non-stationary time-series events in a lookback window are encoded into corresponding measurement vectors. For example, referring back to FIG. 1, encoder 10 encodes observations at multiple time segments in the lookback window 50 into measurement vectors 12, 14, 15, etc.

As shown in block 520, the time series is mapped to functional space by applying predefined measurement functions with learned coefficients to the measurement vectors. Such measurement functions may span the Koopman space. The measurement functions may be canonical nonlinear functions. The encoder may be used to generate the coefficients of the measurement functions. In some examples, a latent matrix is generated, where each vector in the latent matrix is a linear transformation of the observations. In such examples, the measurement functions may be defined in latent space rather than observational space. Applying predefined measurement functions to the latent matrix produces a result that may be flattened into a vector. As shown in block 530, shared characteristics among the observations are learned using a Koopman global operator. Such shared characteristics may be an indicator of trend.

As shown in block 540, local changing dynamics among the observations are captured using a Koopman local operator. The local operator may depend on a time t and vary across autoregressive steps, adapting to distribution changes along prediction.

As shown in block 550, a forecast is generated based on the measurement vectors and Koopman operators. Koopman operator may be a [nd×nd] matrix. The forecast may be output, such as by decoding forecasted measurement vectors using a decoder.

As shown in block 560, forecasting errors are identified. For example, differences between predictions on the lookback window and the observed data may be used to generate an adjustment operator. The adjustment operator may be, for example, a diagonal matrix.

In block 570, the Koopman operators may be updated based on forecasting errors, to improve the accuracy of future forecasts. For example, if predictions deviate significantly from ground truth within the lookback window, the adjustment operator may learn the temporal change in the underlying dynamics. The adjustment operator may correspondingly adjust the global and local operators. As an example, the global and local operators may be updated to a latest distribution in the lookback window.

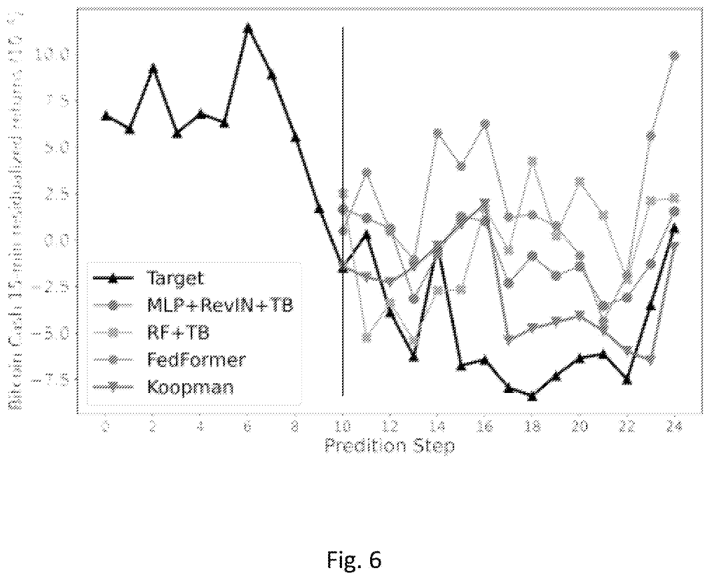

FIG. 6 is a graph illustrating forecasts in a first example use case, related to forecasts on cryptocurrency datasets. As shown, KNF captures both overall trends and small fluctuations with accuracy.

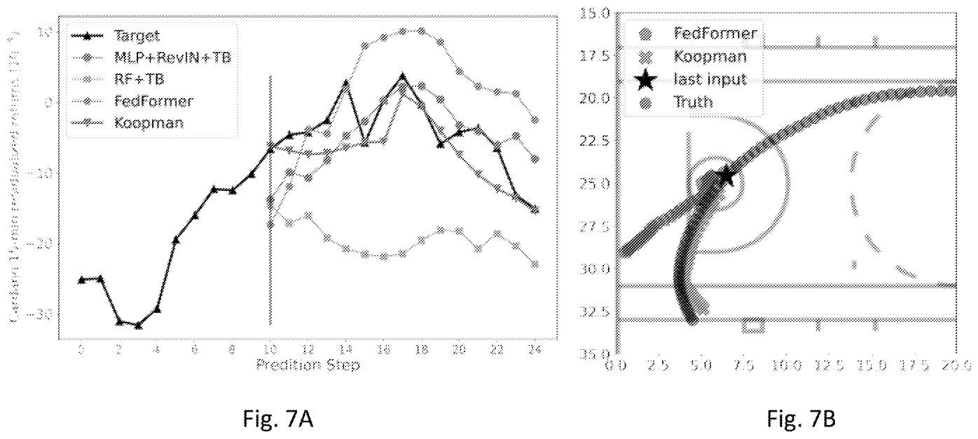

FIG. 7A is a graph illustrating forecasts in a second example use case, related to forecasting player trajectories in an athletic event, such as how players will move across a basketball court in a basketball game. FIG. 7B is a top view depiction of forecasted basketball player trajectories relative to a basketball court. As shown in FIG. 7A, KNF may be used to accurately predict whether or when a player will change directions, while other prediction models fail.

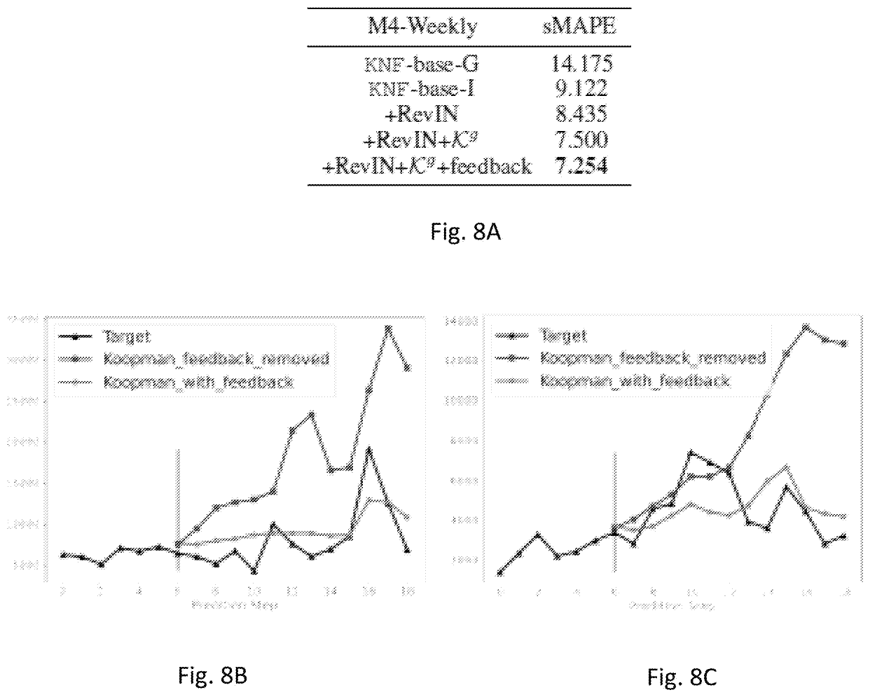

FIG. 8A is a table illustrating an ablation study of KNF on weekly data from the M4 Competition. The table includes a Symmetric mean absolute percentage error (sMAPE) of ensemble predictions from five functions of each variant. KNF-base-G uses purely data driven measurements. KNF-base-I uses predefined measurement functions, which outperform KNF-base-G. Adding ReVIN, the global Koopman operator, or the feedback loop also brings improvement.

FIGS. 8B-C are graphs illustrating example M4 predictions from KNF. As seen in such figures, the predictions from the model with the feedback loop removed start to deviate from the ground truth after a few steps. The feedback loop can cope with temporal distribution shifts and thus improve the long-horizon forecasting accuracy.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A computer-implemented method for time-series forecasting, comprising:
encoding, with an encoder, multiple steps of observations of non-stationary time-series events in a lookback window into corresponding measurement vectors;
applying, with one or more processors, predefined measurement functions with learned coefficients to the measurement vectors;
determining, with the one or more processors based on analysis of the observations, Koopman operators;
generating, with the one or more processors, a forecast vector based on the measurement vectors and Koopman operators; and
providing, with the one or more processors a forecast for output based on the forecast vector.

2. The method of claim 1, further comprising:
computing a latent matrix in which each measurement vector is a different linear transformation of a respective observation at a corresponding time step; and
applying the measurement functions to the latent matrix.

3. The method of claim 1, further comprising: reconstructing, using a decoder, observations from the forecast vector.

4. The method of claim 3, wherein the encoder and the decoder are any deep neural network architecture including multi-layer perceptron.

5. The method of claim 1 wherein the predefined measurement functions contain at least one of polynomials, exponential functions, trigonometric functions, or other interaction functions.

6. The method of claim 1, wherein the predefined measurement functions impose inductive biases into the forecast.

7. The method of claim 1, wherein the encoder approximates parameters of the measurement functions without directly learning non-stationary characteristics.

8. The method of claim 1, wherein the Koopman operator is a finite matrix using a global operator and a local operator to model propagation of dynamics.

9. The method of claim 8, further comprising applying the global operator and the local operator recursively to measurements to obtain predictions on a lookback window.

10. The method of claim 9, further comprising adjusting the Koopman operator based on differences between the predictions on the lookback window and a ground truth.

11. A computer-implemented system for time-series forecasting, comprising:
memory; and
one or more processors in communication with the memory and configured to:
encode, using an encoder, multiple steps of observations of non-stationary time-series events in a lookback window into corresponding measurement vectors;
apply predefined measurement functions with learned coefficients to the measurement vectors;
determine, based on analysis of the observations, Koopman operators;
generate a forecast vector based on the measurement vectors and Koopman operators; and
provide a forecast for output based on the forecast vector.

12. The system of claim 11, wherein generating the forecast vector comprises:
computing a latent matrix in which every vector is a linear transformation of a respective observation at a corresponding time step; and
applying the measurement functions to the latent matrix.

13. The system of claim 12, wherein generating the forecast vector further comprises reconstructing, using a decoder, observations from the forecast vector.

14. The system of claim 13, wherein the encoder and the decoder are any deep neural network architecture including multi-layer perceptron.

15. The system of claim 11 wherein the predefined measurement functions contain at least one of polynomials, exponential functions, trigonometric functions, or other interaction functions.

16. The system of claim 11, wherein the predefined measurement functions impose inductive biases into the forecast.

17. The system of claim 11, wherein the encoder approximates parameters of the measurement functions without directly learning non-stationary characteristics.

18. The system of claim 11, wherein the Koopman operator is a finite matrix using a global operator and a local operator to model propagation of dynamics.

19. The system of claim 18, further comprising applying the global operator and the local operator recursively to measurements to obtain predictions on a lookback window.

20. The system of claim 19, further comprising adjusting the Koopman operator based on differences between the predictions on the lookback window and ground truth.

21. A non-transitory computer-readable medium storing instructions executable by one or more processors for performing a method, comprising:
encoding multiple steps of observations of non-stationary time-series events in a lookback window into corresponding measurement vectors;
applying predefined measurement functions with learned coefficients to the measurement vectors;
determining, based on analysis of the observations, Koopman operators;
generating a forecast vector based on the measurement vectors and Koopman operators; and
providing a forecast for output based on the forecast vector.
